(19) United States
(12) Patent Application Publication
(10) Pub. No.: US 2011/0146873 A1
(43) Pub. Date: Jun. 23, 2011

(54) PNEUMATIC TIRE WITH RUBBER COMPONENT CONTAINING EPOXIDIZED PALM OIL

(76) Inventors: Marc Weydert, Strassen (LU); Andreas Frantzen, Trier (DE); Patrick Wladislaw Stanislas Kunysz, Arlon (BE)

(21) Appl. No.: 12/644,052

(22) Filed: Dec. 22, 2009

(51) Int. Cl. B60C 1/00; C08K 5/1515

(52) U.S. Cl. 152/525; 152/547

(57) ABSTRACT

The present invention is directed to a pneumatic tire comprising at least one component selected from the group consisting of beads, apexes, and sidewall veneers, the at least one component comprising a rubber composition, the rubber composition comprising:
at least one diene based elastomer;
an epoxidized palm oil;
wherein the rubber composition comprises less than 1 phr of stearic acid.

### BACKGROUND

Vulcanization, or curing, is a process where elastomers, natural and/or synthetic, are mixed with various materials which will cause the elastomer to undergo crosslinking upon application of heat. These materials are conventionally compounded with the elastomer to help improve the elastomer's cured physical properties, e.g., tensile strength and temperature sensitivity. Vulcanization and the resulting improved properties may be obtained by reacting the raw elastomer with sulfur in the presence of other cure activators. Fatty acids, i.e., oleic and stearic, have been commonly used as activators in sulfur vulcanization of diene rubbers in the presence of zinc oxide and an accelerator. During the early stages of vulcanization, the zinc carboxylate (the reaction product of zinc oxide and fatty acid) reacts with the accelerator to form a complex. A nucleophilic attack by the complex on the ring of orthorhombic sulfur results in the formation of a zinc perthiomercaptide complex. This zinc perthiomercaptide complex is believed to be the sulfurating agent responsible for the crosslinking of the elastomer's chains. The role of the fatty acid, i.e., oleic or stearic, is believed to increase the solubility of zinc oxide and subsequent reactivity of the zinc perthiomercaptide complex. Stearic acid is commonly used for vulcanization; however, the stearic acid suffers from the disadvantage of a high bloom rate, consequently causing some loss of adhesion properties. In particular, stearic acid bloom results in poor tack retention in tire components such as beads, apexes, and sidewall veneers stored for later tire building. Especially problematic is loss of tack in such components of large industrial and off-the-road tires. Therefore, there exists a need for improved tack retention in tire components.

### SUMMARY

The present invention is directed to a pneumatic tire comprising at least one component selected from the group consisting of beads, apexes, and sidewall veneers, the at least one component comprising a rubber composition, the rubber composition comprising:

at least one diene based elastomer;

an epoxidized palm oil;

wherein the rubber composition comprises less than 1 phr of stearic acid.

### DESCRIPTION

There is disclosed a pneumatic tire comprising at least one component selected from the group consisting of beads, apexes, and sidewall veneers, the at least one component comprising a rubber composition, the rubber composition comprising:

at least one diene based elastomer;

an epoxidized palm oil;

wherein the rubber composition comprises less than 1 phr of stearic acid.

The rubber composition includes an epoxidized palm oil. The epoxidized palm oil is derived from a palm oil. Typical palm oils are comprised of about 43 to 47 percent by weight of palmitic acid, about 38 to 42 percent by weight of oleic acid, about 8 to 12 percent by weight of linoleic acid, about 3 to 5 percent by weight of stearic acid, and from about 0.5 to 1.5 percent by weight of myristic acid. Epoxidized palm oil is produced by epoxidation of palm oil, following methods such as those disclosed for example in GB1,382,853 or JP11-158486. Typically, palm oil is epoxidized such that a fraction of the double bonds in the palm oil fatty acids are converted to epoxide (i.e., oxirane) functional groups. In one embodiment, from about 2.4 to about 3.6 percent of available double bonds in the palm oil fatty acids are converted to epoxide groups in the epoxidized palm oil. In one embodiment, from about 2.6 to 3.4 percent of available double bonds in the palm oil fatty acids are converted to epoxide groups in the epoxidized palm oil. Suitable epoxidized palm oil is available commercially as Ultra-Flex™ EPO from Performance Additives.

Use of epoxidized palm oil in the rubber composition makes use of other sources of fatty acid unnecessary. In particular, the usual addition of stearic acid as a cure aid is not required; the usual bloom experience with stearic acid and its concomitant effect on tack of the rubber component is avoided. A small amount of stearic acid is nonetheless included in the rubber composition due to its presence in the epoxidized palm oil. In one embodiment, the rubber composition comprises less than 1 phr of stearic acid. In one embodiment, the rubber composition comprises less than 0.75 phr of stearic acid.

The rubber composition includes at least one additional diene based rubber. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. The preferred rubber or elastomers are natural rubber, synthetic polyisoprene, polybutadiene and SBR.

In one aspect the rubber is preferably of at least two of diene based rubbers. For example, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, cis 1,4-polybutadiene rubbers and emulsion polymerization prepared butadiene/acrylonitrile copolymers.

In one aspect of this invention, an emulsion polymerization derived styrene/butadiene (E-SBR) might be used having a relatively conventional styrene content of about 20 to about 28 percent bound styrene or, for some applications, an E-SBR having a medium to relatively high bound styrene content, namely, a bound styrene content of about 30 to about 45 percent.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

In one embodiment, c is 1,4-polybutadiene rubber (BR) may be used. Such BR can be prepared, for example, by organic solution polymerization of 1,3-butadiene. The BR may be conveniently characterized, for example, by having at least a 90 percent cis 1,4-content.

The cis 1,4-polyisoprene and cis 1,4-polyisoprene natural rubber are well known to those having skill in the rubber art.

In one embodiment, c is 1,4-polybutadiene rubber (BR) is used. Suitable polybutadiene rubbers may be prepared, for example, by organic solution polymerization of 1,3-butadiene. The BR may be conveniently characterized, for example, by having at least a 90 percent cis 1,4-content and a glass transition temperature Tg in a range of from −95 to −105° C. Suitable polybutadiene rubbers are available commercially, such as Budene® 1207 from Goodyear and the like.

In one embodiment, a synthetic or natural polyisoprene rubber may be used.

A reference to glass transition temperature, or Tg, of an elastomer or elastomer composition, where referred to herein, represents the glass transition temperature(s) of the respective elastomer or elastomer composition in its uncured state or possibly a cured state in a case of an elastomer composition. A Tg can be suitably determined as a peak midpoint by a differential scanning calorimeter (DSC) at a temperature rate of increase of 10° C. per minute.

The term “phr” as used herein, and according to conventional practice, refers to “parts by weight of a respective material per 100 parts by weight of rubber, or elastomer.”

The rubber composition may also include processing oil. However, the epoxidized palm oil may partially or completely replace any usual amounts of processing oil. To the extent it is used, then, processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as MES, TDAE, SRAE and heavy naphthenic oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

The rubber composition may include from about 10 to about 100 phr of silica.

The commonly employed siliceous pigments which may be used in the rubber compound include conventional pyrogenic and precipitated siliceous pigments (silica). In one embodiment, precipitated silica is used. The conventional siliceous pigments employed in this invention are precipitated silicas such as, for example, those obtained by the acidification of a soluble silicate, e.g., sodium silicate.

Such conventional silicas might be characterized, for example, by having a BET surface area, as measured using nitrogen gas. In one embodiment, the BET surface area may be in the range of about 40 to about 600 square meters per gram. In another embodiment, the BET surface area may be in a range of about 80 to about 300 square meters per gram. The BET method of measuring surface area is described in the Journal of the American Chemical Society, Volume 60, Page 304 (1930).

The conventional silica may also be characterized by having a dibutylphthalate (DBP) absorption value in a range of about 100 to about 400, alternatively about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc.

Commonly employed carbon blacks can be used as a conventional filler in an amount ranging from 10 to 100 phr. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

Other fillers may be used in the rubber composition including, but not limited to, particulate fillers including ultra high molecular weight polyethylene (UHMWPE), crosslinked particulate polymer gels including but not limited to those disclosed in U.S. Pat. Nos. 6,242,534; 6,207,757; 6,133,364; 6,372,857; 5,395,891; or 6,127,488, and plasticized starch composite filler including but not limited to that disclosed in U.S. Pat. No. 5,672,639. Such other fillers may be used in an amount ranging from 1 to 30 phr.

In one embodiment the rubber composition may contain a conventional sulfur containing organosilicon compound. Examples of suitable sulfur containing organosilicon compounds are of the formula:

Z-Alk-Sₙ-Alk-Z I

in which Z is selected from the group consisting of

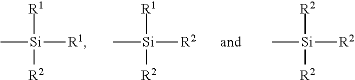

where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

In one embodiment, the sulfur containing organosilicon compounds are the 3,3′-bis(trimethoxy or triethoxy silylpropyl)polysulfides. In one embodiment, the sulfur containing organosilicon compounds are 3,3′-bis(triethoxysilylpropyl)disulfide and/or 3,3′-bis(triethoxysilylpropyl)tetrasulfide. Therefore, as to formula I, Z may be

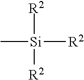

where R² is an alkoxy of 2 to 4 carbon atoms, alternatively 2 carbon atoms; alk is a divalent hydrocarbon of 2 to 4 carbon atoms, alternatively with 3 carbon atoms; and n is an integer of from 2 to 5, alternatively 2 or 4.

In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials.

In another embodiment, suitable sulfur containing organosilicon compounds include those disclosed in U.S. Patent Publication No. 2003/0130535. In one embodiment, the sulfur containing organosilicon compound is Si-363 from Degussa.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, zinc oxide, waxes, antioxidants and antiozonants and peptizing agents. Fatty acids in addition to those present in the epoxidized palm oil are not added. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants comprise about 1 to 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound. Suitable guanidines include dipheynylguanidine and the like. Suitable thiurams include tetramethylthiuram disulfide, tetraethylthiuram disulfide, and tetrabenzylthiuram disulfide.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The rubber composition may be incorporated in a bead wirecoat, apex, or sidewall veneer of the tire. A typical bead with skim coat, or wirecoat, is described for example in U.S. Pat. No. 6,120,911 and U.S. Pat. No. 6,966,351. A typical apex is described in U.S. Pat. No. 6,776,206. A typical sidewall veneer for a large tire is described for example in U.S. Pat. No. 6,223,796. In one embodiment, the component is a bead wirecoat.

The pneumatic tire of the present invention may be a race tire, passenger tire, aircraft tire, industrial, earthmover, off-the-road, truck tire, and the like. The tire may also be a radial or bias.

In one embodiment, the tire is a large truck, industrial, or off-the-road type tire. In such large tires, maintaining good adhesion between components during tire build is important due to the large dimensions and high stresses experienced by the tire. To this end, a sufficient level of tack, or stickiness, of certain components such as the bead, apex, and any sidewall veneers is important to obtain good adhesion in the final tire. By large tire, it is meant that the tire size is at least a 24 inch wheel diameter. In one embodiment, then, the tire has a wheel diameter greater than 24 inches. In one embodiment, the tire has a wheel diameter greater than 30 inches. In one embodiment, the tire has a wheel diameter greater than 36 inches.

As is known in the art, bead wire is typically coated with a rubber compound before bundling the wire into a bead. To add cohesiveness between the bead wires and as an aid in providing tack to the bead, a fabric impregnated with an adhesive is sometimes wrapped around the bead, see for example U.S. Pat. No. 4,501,791; U.S. Pat. No. 4,097,321; and U.S. Pat. No. 7,578,328 for examples of so-called bead wraps, methods for wrapping beads, and tires with bead wraps. In addition, in the splice area of the bead, that is, the area where the wire ends are exposed, it is sometimes necessary to wrap the bead with a bead wrap to secure the wire ends and prevent these wire ends from extending into the adjacent tire components. Such splice wraps are typically disposed within about 3 cross-sectional dimensions of the splice (by cross-sectional dimensions, it is meant the maximum length in cross-section of the bead; for a round bead this would be the diameter). The use of such bead wraps adds complexity and cost to the tire building process; it is desirable to avoid using such wraps if possible. The use of an improved bead wirecoat compound may allow for the elimination of the bead wrap, except in the area of the splice. In one embodiment, then, the tire component is a bead with a bead wirecoat comprising the epoxidized palm oil.

Vulcanization of the pneumatic tire of the present invention is generally carried out at conventional temperatures ranging from about 100° C. to 200° C. In one embodiment, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The invention is further illustrated by the following non-limiting example.

### Example 1

In this example, a rubber composition including an epoxidized palm oil is illustrated. Rubber compounds were prepared following a multi-step mix procedure. The compounds had formulation as indicated in Table 1, with all amounts given in phr. The samples were tested for physical properties with results given in Table 2.

SBAT corresponds to ASTM D1871 Method 1.

Mooney viscosities (ML.sub.1+4 (100° C.)) and Mooney scorch (t+5, T+20) were measured on a Flexsys MV2000.

Viscoelastic properties Tan Delta and G′ were measured using an Alpha Technologies Rubber Process Analyzer (RPA). A description of the RPA 2000, its capability, sample preparation, tests and subtests can be found in these references. H A Pawlowski and J S Dick, Rubber World, June 1992; J S Dick and H A Pawlowski, Rubber World, January 1997; and J S Dick and J A Pawlowski, Rubber & Plastics News, Apr. 26 and May 10, 1993.

TABLE 1

| Sample No. | 1 | 2 | 3 |
|---|---|---|---|
| Elastomers | 100 | 100 | 100 |
| Carbon Black | 124 | 125 | 110 |
| Silica | 15.3 | 15 | 0 |
| Resins | 7.17 | 4 | 17.7 |
| Zinc Oxide | 5 | 5 | 4.5 |
| Sulfur | 5 | 4 | 4 |
| Accelerators | 1.57 | 1.7 | 1.5 |
| Rosin Oil | 20 | 0 | 0 |
| Naphthenic Oil | 0 | 25 | 0 |
| Epoxidized Palm Oil | 0 | 0 | 15 |
| Stearic Acid | 3 | 3 | 0 |

TABLE 2

| | | | |
|---|---|---|---|
| Sample No. | 1 | 2 | 3 |

MV2000 Plasticity.
Test: @ 100° C., Rotor Type = Small

| | | | |
|---|---|---|---|
| Final Viscosity, Mooney Units | 68.6 | 56.8 | 54.4 |

MV2000 SCORCH
Test: @ 121° C., Rotor Type = Small

| | | | |
|---|---|---|---|
| T + 5, minutes | 23.9 | 5.6 | 16.6 |
| T + 20, minutes | 45.2 | 55.0 | 19.3 |

RPA2000
Test: @ 100° C., Frequency = 1 Hz, Strain Sweep = 1/2/5/10, Strain
Sweep = 1/2/5/10/15/50

| | | | |
|---|---|---|---|
| G′ 1%, MPa | 8.6 | 7.7 | 9.3 |
| G′ 5%, MPa | 5.8 | 5.3 | 5.3 |
| G′ 15%, MPa | 4.6 | 4.1 | 3.6 |

Cold Tensile DIN 53504
Cure: 74 min @ 160° C.; Test: @ 23° C., Pulling Speed = 20 cm/min

| | | | |
|---|---|---|---|
| Elongation at Break, % | 115 | 106 | 177 |
| 100% Modulus, MPa | 12.6 | 12.7 | 7.5 |
| Tensile Strength, MPa | 14.6 | 13.4 | 14.5 |
| Shore D | 50 | 44 | 41 |

SBAT-Bead Wire Adhesion
Cure: 74 min @ 160° C.; Test: @ 23° C. .072″

| | | | |
|---|---|---|---|
| Pull Out Force, Original, N | 1894 | 1539 | 1092 |
| Pull Out Force, Aged 2 days at 121° C., N | 588 | 447 | 904 |
| Pull Out Force, Aged 5 day at 121° C., N | 499 | 189 | 321 |

### Example 2

In this example, the ability to retain tack by tire components made with the rubber composition including epoxidized palm oil is illustrated. The “tackiness” or tack of a rubber component is a relative indication of the ability of the component to adhere and remain adhered to other tire components during the tire building process. Some tire components, including beads, apexes, and sidewall veneers, are typically produced in advance of tire building and may be stored for several weeks before use.

Beads produced using compounds of Example 1 were stored up to three months and evaluated for tack. These evaluations showed that the beads produced using epoxidized palm oil according to the present invention had at least 50 percent superior tack retention as compared with the control beads.

Such tack may be measured by a technique described in the publication “Role of Phenolic Tackifiers in Polyisoprene Rubber,” F. L. Magnus and G. R. Hamed, Rubber Chemistry and Technology, vol. 64, pages 65-73 (1991).

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire comprising at least one component selected from the group consisting of beads, apexes, and sidewall veneers, the at least one component comprising a rubber composition, the rubber composition comprising:
at least one diene based elastomer;
an epoxidized palm oil;
wherein the rubber composition comprises less than 1 phr of stearic acid.

2. The pneumatic tire of claim 1, wherein the epoxidized palm oil is derived from a palm oil comprising from 43 to 47 percent by weight of palmitic acid, from 38 to 42 percent by weight of oleic acid, from 8 to 12 percent by weight of linoleic acid, from 3 to 5 percent by weight of stearic acid, and from 0.5 to 1.5 percent by weight of myristic acid.

3. The pneumatic tire of claim 1, wherein the amount of epoxidized palm oil ranges from 1 to 20 phr.

4. The pneumatic tire of claim 1, wherein the amount of epoxidized palm oil ranges from 3 to 18 phr.

5. The pneumatic tire of claim 1, wherein the amount of epoxidized palm oil ranges from 5 to 15 phr.

6. The pneumatic tire of claim 1, wherein the component is a bead having a cross-sectional length, and the bead excludes a fabric bead wrap disposed beyond three cross-sectional lengths of a bead splice.

7. The pneumatic tire of claim 1, wherein the rubber composition comprises less than 0.75 phr of stearic acid.

8. The pneumatic tire of claim 1, wherein the rubber composition comprises less than 0.5 phr of stearic acid.

9. The pneumatic tire of claim 1, wherein the epoxidized palm oil has 2.4 to 3.6 percent of epoxidation.

10. The pneumatic tire of claim 1, wherein the epoxidized palm oil has 2.6 to 3.4 percent of epoxidation.

11. The pneumatic tire of claim 1, wherein the tire is sized for a wheel diameter of at least 24 inches.

12. The pneumatic tire of claim 1, wherein the tire is sized for a wheel diameter of at least 30 inches.

13. The pneumatic tire of claim 1, wherein the tire is sized for a wheel diameter of at least 36 inches.
